(19) United States
(12) Patent Application Publication
(10) Pub. No.: US 2016/0355012 A1
(43) Pub. Date: Dec. 8, 2016

(54) LIQUID DISCHARGE APPARATUS

(71) Applicants: Ryuuta KATOH, Kanagawa (JP); Shino SASAKI, Kanagawa (JP); Yukihito NIINO, Tokyo (JP)

(72) Inventors: Ryuuta KATOH, Kanagawa (JP); Shino SASAKI, Kanagawa (JP); Yukihito NIINO, Tokyo (JP)

(73) Assignee: Ricoh Company, Ltd., Tokyo (JP)

(21) Appl. No.: 15/175,199

(22) Filed: Jun. 7, 2016

(30) Foreign Application Priority Data
Jun. 8, 2015 (JP) 2015-116158

(51) Int. Cl. B41J 2/14

(52) U.S. Cl. CPC B41J 2/14

(57) ABSTRACT

A liquid discharge apparatus includes a liquid discharge head, a dummy discharge controller, and a storage device. The liquid discharge head includes a plurality of nozzles to discharge liquid, onto a continuous medium. The dummy discharge controller is configured to control the liquid discharge head to discharge dummy discharge droplets linearly in an inter-page area of the continuous medium. The storage device is configured to retain a plurality of dummy discharge patterns that differs from each other in number of droplets continuously discharged in at least one direction of a feed direction of the continuous medium and a direction perpendicular to the feed direction.

### CROSS-REFERENCE TO RELATED APPLICATION

This patent application is based on and claims priority pursuant to 35 USC. §119(a) to Japanese Patent Application No. 2015-116158, filed on Jun. 8, 2015, in the Japan Patent Office, the entire disclosure of which is hereby incorporated by reference herein.

### BACKGROUND

Technical Field

Aspects of this disclosure relate to a liquid discharge apparatus.

Related Art

A liquid discharge apparatus to discharge liquid onto a continuous medium performs dummy discharge operation to discharge dummy discharge droplets for a purpose, other than a main purpose of the apparatus, that maintains and recovers conditions of nozzles of a liquid discharge head as a liquid discharge device. Examples of the continuous medium include rolled sheet of paper, continuous sheet of paper, continuous-form paper web medium. Examples of dummy discharge include flushing and preliminary discharge.

### SUMMARY

In an aspect of this disclosure, there is provided a liquid discharge apparatus that includes a liquid discharge head, a dummy discharge controller, and a storage device. The liquid discharge head includes a plurality of nozzles to discharge liquid onto a continuous medium. The dummy discharge controller is configured to control the liquid discharge head to discharge dummy discharge droplets linearly in an inter-page area of the continuous medium. The storage device is configured to retain a plurality of dummy discharge patterns that differs from each other in number of droplets continuously discharged in at least one direction of a feed direction of the continuous medium and a direction perpendicular to the feed direction.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a side view of an example of a liquid discharge apparatus according to an embodiment of the present disclosure;

FIG. 2 is a plan view of a portion of a liquid discharge device according to an embodiment of the present disclosure;

FIG. 3 is a cross-sectional view of an example of one liquid discharge head constituting part of a head unit according to an embodiment of the present disclosure, cut along a direction perpendicular to a nozzle array direction (i.e., a longitudinal direction of a liquid chamber);

FIG. 4 is a cross-sectional view of the liquid discharge head of FIG. 3 cut along the nozzle array direction (the transverse direction of the liquid chamber);

FIG. 5 is a block diagram of a control unit of the liquid discharge apparatus according to an embodiment of the present disclosure;

FIG. 6 is a block diagram of a higher-level device constituting the control unit of FIG. 5;

FIG. 7 is a block diagram of an output control device constituting the control unit of FIG. 5;

FIGS. 8A, 8B, 8C, 8D, and 8E are illustrations of examples of a plurality of dummy discharge patterns used in an embodiment of the present disclosure;

FIG. 9 is a flowchart of a general flow of print control according to embodiments of the present disclosure;

FIG. 10 is a flowchart of a control on the selection of a flushing pattern according to a first embodiment of the present disclosure;

FIG. 11 is a flowchart of a control on the selection of a flushing pattern according to a second embodiment of the present disclosure;

FIGS. 12A and 12B (collectively referred to as FIG. 12) are a flowchart of a control on the selection of a flushing pattern according to a third embodiment of the present disclosure;

FIG. 13 is a flowchart of a control on the selection of a flushing pattern according to a fourth embodiment of the present disclosure;

FIG. 14 is an illustration of an example of the relationship between the drive frequency and the amount of thickened liquid in nozzle during continuous printing; and

FIG. 15 is an illustration of an example of a table of the relationship between humidity, medium type, and flushing pattern.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

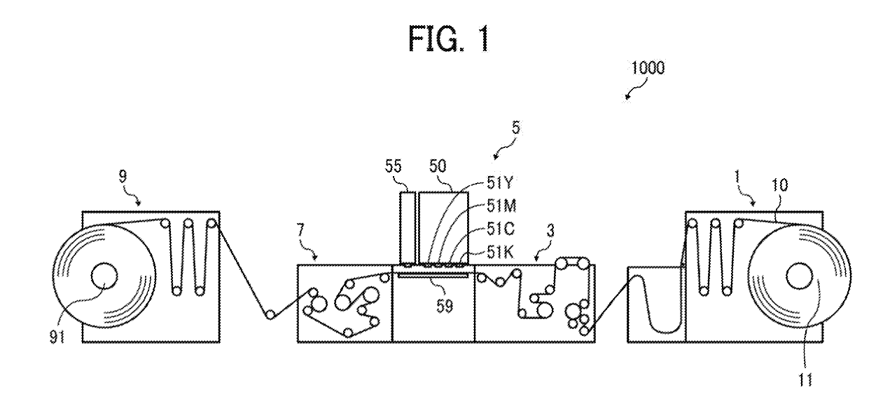

Referring now to the drawings, wherein like reference numerals designate identical or corresponding parts throughout the several views, exemplary embodiments of the present disclosure are described below. First, a liquid discharge apparatus 1000 according to an embodiment of this disclosure is described with reference to FIG. 1. FIG. 1 is an illustration of the liquid discharge apparatus 1000 according to this embodiment.

The liquid discharge apparatus 1000 includes a feeder 1 to feed a continuous medium 10, a guide conveyor 3 to guide and convey the continuous medium 10, fed from the feeder 1, to a printing unit 5, the printing unit 5 to discharge liquid onto the continuous medium 10 to form an image on the continuous medium 10, a drier unit 7 to dry the continuous medium 10, and an ejector 9 to eject the continuous medium 10.

The continuous medium 10 is fed from a root winding roller 11 of the feeder 1, guided and conveyed with rollers of the feeder 1, the guide conveyor 3. the drier unit 7, and the ejector 9, and wound around a winding roller 91 of the ejector 9.

In the printing unit 5, the continuous medium 10 is conveyed opposite a liquid discharge device 50 and a liquid discharge device 55 on a conveyance guide 59. The liquid discharge device 50 discharges liquid to form an image on the continuous medium 10. Post-treatment is performed on the continuous medium 10 with treatment liquid discharged from the liquid discharge device 55.

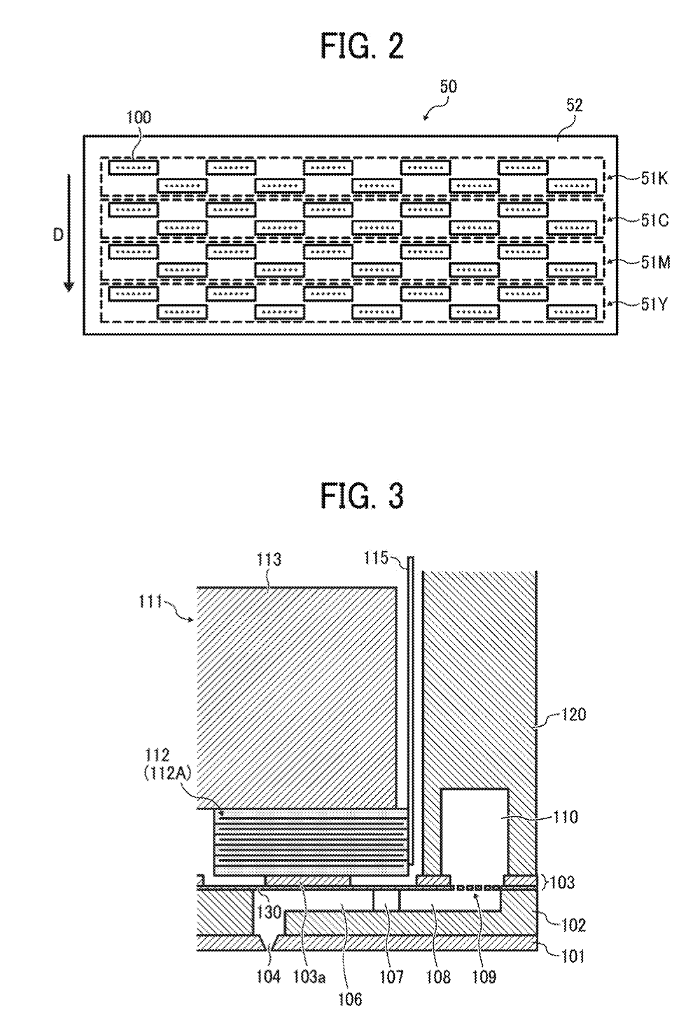

Here, the liquid discharge device 50 includes, for example, four-color full-line head units 51K, 51C, 51M, and 51Y (hereinafter, collectively referred to as “head units 51” unless colors are distinguished) from an upstream side in a feed direction of the continuous medium 10 (hereinafter, “medium teed direction”) indicated by arrow D in FIG. 2.

The head units 51K, 51C, 51M, and 51Y are liquid discharge devices to discharge liquid of black (K), cyan (C), magenta (M), and yellow (Y) onto the continuous medium 10. It is to be noted that the number and types of color is not limited to the above-described four colors of K. C, M. and Y and may be any other suitable number and types.

In each head unit 51, for example, as illustrated in FIG. 2, a plurality of liquid discharge heads (also referred to as simply “heads”) 100 are arranged in a staggered manner on a base 52 to form a head array. However, the configuration of the head unit 51 is not limited to such a configuration. In this embodiment, each head unit 51 includes a liquid discharge head unit including liquid discharge heads and head tanks to supply liquid to the liquid discharge heads. However, it is to be noted that the configuration of the head unit is not limited to such a configuration. Each head unit may be formed of, e.g., only the liquid discharge head(s).

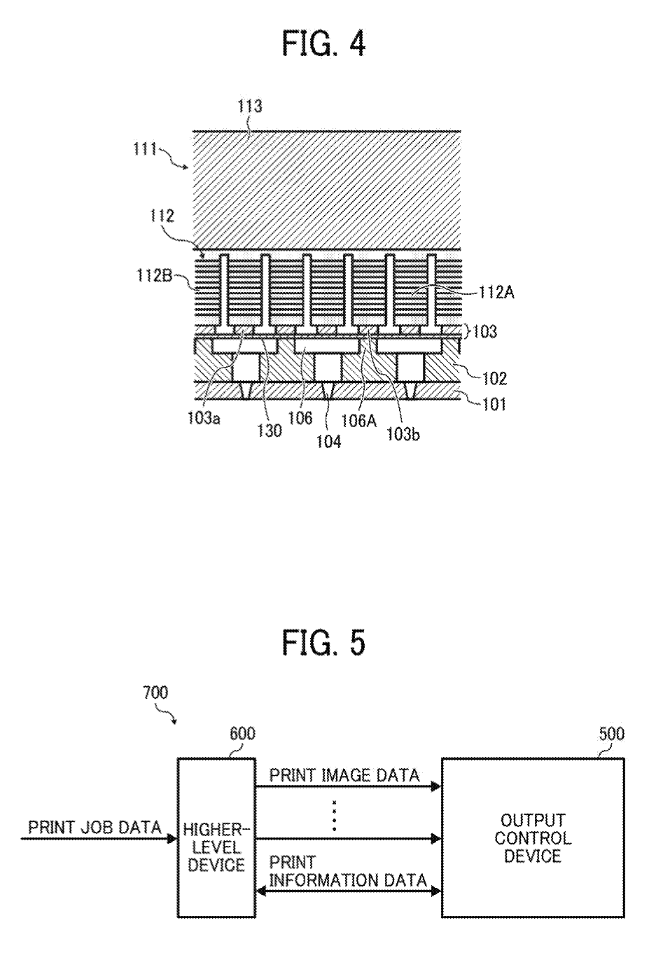

Next, an example of one liquid discharge head constituting the head unit is described with reference to FIGS. 3 and 4. FIG. 3 is a cross-sectional view of the liquid discharge head cut along a direction (liquid-chamber longitudinal direction) perpendicular to a nozzle array direction. FIG. 4 is a cross-sectional view of the liquid discharge bead cut along the nozzle array direction (liquid-chamber transverse direction).

In the liquid discharge head 100, a nozzle pate 101, a channel plate (liquid chamber substrate) 102, and a diaphragm plate 103 are bonded together. The liquid discharge head 100 includes piezoelectric actuator 111 to displace the diaphragm plate 103 and a frame 120 as a common channel member.

Thus, individual chambers (also referred to as pressure chambers or pressurizing chambers) 106 communicated with a plurality of nozzles 104 to discharge droplets, liquid supply passages 107 (also serving as fluid restrictors) to supply liquid to the individual liquid chambers 106, and liquid introduction portions 108 communicated with the liquid supply passages 107. Adjacent ones of the individual liquid chambers 106 are separated with a partition 106A.

Liquid is supplied from a common liquid chamber 110 as a common channel of the frame 120 to each individual liquid chamber 106 through a filter 109, the liquid introduction portion 108, and the liquid supply passage 107. The filters 109 are formed in the diaphragm plate 103.

The piezoelectric actuator 111 is disposed opposite the individual liquid chamber 106 with a deformable vibration region 130 interposed between the piezoelectric actuator 111 and the individual liquid chamber 106. The vibration region 130 constitutes part of a wall of the individual liquid chamber 106 of the diaphragm plate 103.

The piezoelectric actuator 111 includes a plurality of laminated piezoelectric members 112 bonded on a base 113. The piezoelectric member 112 is groove-processed by half cut dicing. Pillar-shaped piezoelectric elements (piezoelectric pillars) 112A and support pillars 112B are disposed at predetermined distances in a comb shape.

The piezoelectric elements 112A are bonded to island-shaped projections 103a in the vibration regions 130 of the diaphragm plate 103. The support pillars 112B are bonded to projections 103b of the diaphragm plate 103.

The piezoelectric member 112 includes piezoelectric layers and internal electrodes alternately laminated one on another. The internal electrodes are lead out to end faces to form external electrodes. A flexible printed circuit (FPC) 115 as a flexible wiring board is connected to the external electrodes of the piezoelectric element 112A to apply a drive waveform to the piezoelectric element 112A.

The frame 120 includes the common liquid chamber 110 to which liquid is supplied from the head tanks and liquid cartridges.

In the liquid discharge head 100, for example, when the voltage applied to the piezoelectric element 112A is lowered from a reference potential, the piezoelectric element 112A contracts. As a result, the vibration region 130 of the diaphragm plate 103 moves downward and the volume of the individual liquid chamber 106 increases, thus causing liquid to flow into the individual liquid chamber 106.

When the voltage applied to the piezoelectric element 112A is raised, the piezoelectric element 112A expands in the direction of lamination. The vibration region 130 of the diaphragm plate 103 deforms in a direction toward the nozzle 104 and contracts the volume of the individual liquid chamber 106. Thus, liquid in the individual liquid chamber 106 is pressurized and discharged (jetted) from the nozzle 104.

When the voltage applied to the piezoelectric element 112A is returned to the reference potential, the vibration region 130 of the diaphragm plate 103 is returned to the initial position and the individual liquid chamber 106 expands to generate a negative pressure. Accordingly, liquid is replenished from the common liquid chamber 110 to the individual liquid chamber 106 through the liquid supply passage 107. After the vibration of a meniscus surface of the nozzle 104 decays to a stable state, the liquid discharge head 100 shifts to an operation for the next droplet discharge.

Note that the driving method of the liquid discharge head is not limited to the above-described example (pull-push discharge). For example, pull discharge or push discharge may be performed in response to the way to apply the drive waveform.

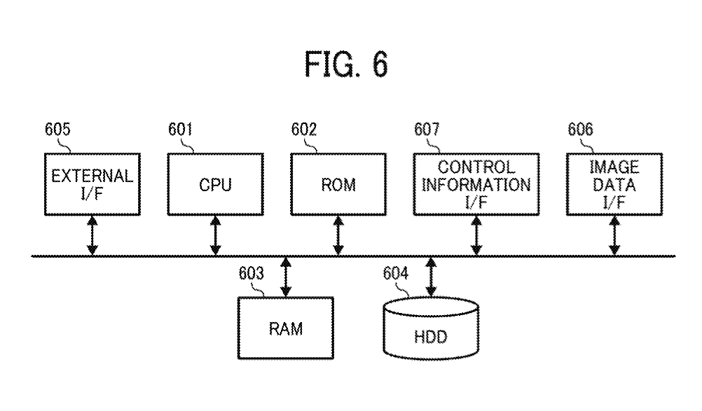

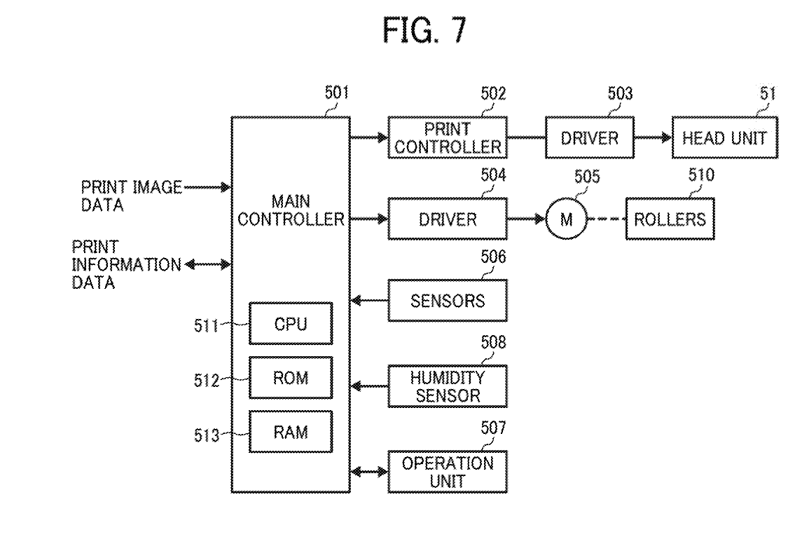

Next, a control unit of the liquid discharge apparatus according to an embodiment of the present disclosure is described with reference to FIGS. 5 through 7. FIG. 5 is a block diagram of the control unit according to the present embodiment. FIG. 6 is a block diagram of a higher-level device constituting part of the control unit. FIG. 7 is a block diagram of an output control device constituting part of the control unit.

The control unit 700 includes a higher-level device 600 and an output control device 500. The higher-level device 600 receives and processes print job data from a host device and transmits the processed data to the output control device 500. The output control device 500 receives print image data from the higher-level device 600 and performs print control.

The higher-level device 600 performs time-consuming processing with a raster image processor (RIP). The output control device 500 performs print processing.

The higher-level device 600 performs processing with the RIP based on the print job data (job data or print data) output from the host device. In other words, the higher-level device 600 creates print image data being bitmap data corresponding to respective colors, based on the print job data.

The higher-level device 600 creates control information data for controlling printing operation, based on, e.g., print job data and information of the host device. Here, the term “control information data” used herein includes data relation to print conditions (print mode, print type, information on sheet feeding and sheet ejection, the order of sheet faces to be printed, print sheet size, data size of print image data, resolution, paper type information, tone, color information, and print page count).

Here, as illustrated in FIG. 6, the higher-level device 600 includes, for example, a central processing unit (CPU) 601, a read only memory (ROM) 602, a random access memory (RAM) 603, a hard disk drive (HDD) 604, an external interface (I/F) 405, an image data I/F 606, a control information I/F 607.

The higher-level device 600 receives the print job data from the host device via the external I/F 605 via the external I/F 605, creates bitmap data of YMCK colors, write the bitmap data onto the RAM 603, compresses and encodes the bitmap data, and stores the encoded data in the HDD 604.

Then, when printing operation is started, the higher-level device 600 decodes the encoded data, temporarily writes the decoded bitmap data onto the RAM 603, reads out the bitmap data, and transfers the bitmap data of respective colors as print image data toward the output control device 500 via the image data I/F 606.

The higher-level device 600 receives and transmits control information data from and to the output control device 500 via the control information I/F 607, in accordance with the progress of printing operation.

As illustrated in FIG. 7, the output control device 500 includes a main controller (system controller) 501 including, e.g., micro computers, such as a CPU 511, a ROM 512, a RAM 513, and input/output (I/O), an image memory, and a communication interface. The CPU 511 generally controls the entire output control device 500.

The main controller 501 transmits print image data to a print controller 502 to form an image on the continuous medium 10 in accordance with print image data and print information data transmitted from the higher-level device 600.

The print controller 502 transfers the image print image data received from the main controller 501 as serial data and outputs to a head driver 503, for example, transfer clock signals, latch signals, and control signals required for the transfer of print data and determination of the transfer.

The print controller 502 includes a drive waveform generator to output a driving waveform including one or more driving pulses to the head driver 503. The drive waveform generator includes, e.g., a digital/analog (D/A) converter, a voltage amplifier, and a current amplifier. The drive waveform generator performs digital/analog conversion on pattern data of a common driving pulse stored on an internal ROM.

In accordance with serially-inputted print image data corresponding to one head unit 51, the head driver 503 selects driving pulses of a driving waveform transmitted from the print controller 502 and applies the selected driving pulses to the piezoelectric element 112A as a pressure generator to discharge liquid. At this time, by selecting a part or all of the driving pulses forming the driving waveform or a part or all of waveform elements forming a driving pulse, the head unit 51 can selectively discharge dots of different sizes, e.g., large droplets, medium droplets, and small droplets.

The main controller 501 controls, via a motor driver 504, driving of rollers 510 including, e.g., the root winding roller 11 of the feeder 1, the rollers of the feeder 1, the guide conveyor 3, the drier unit 7, and the ejector 9, the winding roller 91 of the ejector 9. Note that driving force is not necessarily applied to all of the rollers.

Detection signals from a humidity sensor 508 to detect an ambient humidity and the sensors 506 including various types of sensors are input to the main controller 501. The main controller 501 inputs and outputs various types of information and transmits and receives display information to and from an operation unit 507.

The main controller 501 is also a dummy discharge controller and controls dummy discharge operation (hereinafter, “line flushing operation”) to maintain or recover conditions of the nozzles 104 by discharging dummy discharge droplets linearly in an inter-page area onto the continuous medium 10.

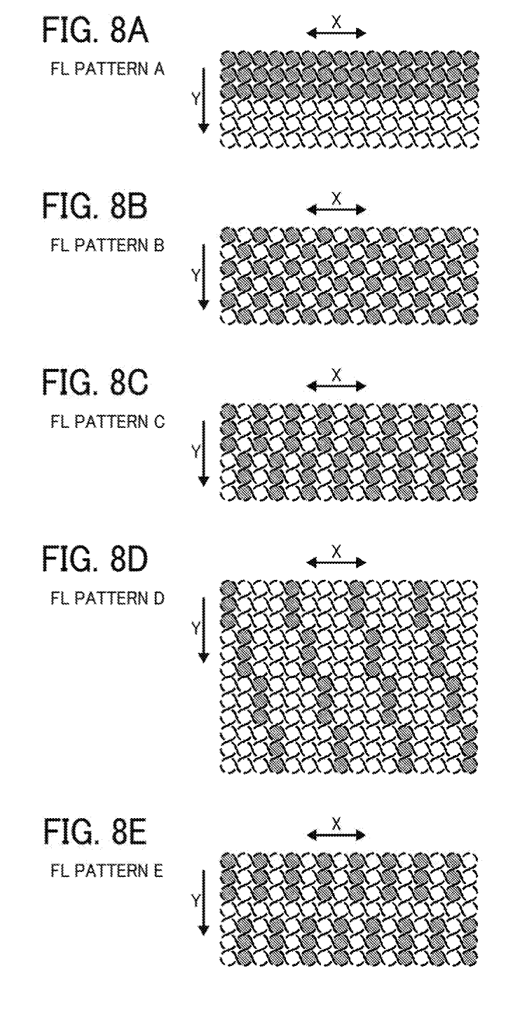

Note that the term “inter-page area” means an area between image formation areas that are areas in which target images are formed. The term “linearly” means that, as illustrated in, e.g., FIG. 8, all dots in at direction perpendicular to a medium feed direction are formed in a width corresponding to one or a few dots in the medium feed direction.

Here, a plurality of different dummy discharge patterns (also referred to as “flushing patterns” used in the line flushing operation is stored and retained in a storage device (e.g., the ROM 602 or the HDD 604) of the higher-level device 600 or the ROM 512 of the main controller 501. In response to a condition, the main controller 501 reads out a flushing pattern from the higher-level device 600 or the ROM 512 to control the line flushing operation.

Next, an example of a plurality of flushing patterns used in an embodiment of the present disclosure is described with reference to FIGS. 8A to 8E. In FIGS. 8A to 8E, the term “flushing” is abbreviated as “FL”. Note that, in matrices of flushing patterns illustrated in FIGS. 8A to 8E, the medium feed direction is a direction indicated by arrow Y (Y direction), and the direction perpendicular to the medium feed direction is a direction indicated by arrow X (X direction).

Flushing (FL) pattern A of FIG. 8A is a pattern formed by discharging dummy discharge droplets continuously both in the X direction and the Y direction onto an area corresponding six dots in the medium feed direction, which is reserved as a dummy discharge (flushing) area. In the flushing pattern A, the number of droplets continuously discharged is equal to the number of nozzles in the X direction and three in the Y direction.

Flushing (FL) pattern B of FIG. 8B is a pattern formed by discharging dummy discharge droplets per two nozzles (per two dots) both in the X direction and the Y direction onto an area corresponding six dots in the medium feed direction, which is reserved as a dummy discharge (flushing) area. In the flushing pattern B, the number of droplets continuously discharged is zero both in the X direction and the Y direction.

Flushing (FL) pattern C of FIG. 8C is a pattern formed by discharging dummy discharge droplets per two nozzles (per two dots) in the X direction and dummy discharge droplets corresponding to three dots continuously in the Y direction, then switching the nozzles to discharge dummy discharge droplets, and similarly discharging dummy discharge droplets corresponding to three dots continuously in the Y direction, onto an area corresponding six dots in the medium feed direction, which is reserved as a flushing area. In the flushing pattern C, the number of droplets continuously discharged is zero in the X direction and three in the Y direction.

Flushing (FL) pattern D of FIG. 8D is a pattern formed by repeating a process of discharging dummy discharge droplets per four nozzles (per four dots) in the X direction and dummy discharge droplets corresponding to three dots continuously in the Y direction, then shifting the nozzles to discharge dummy discharge droplets by one nozzle in the X direction, similarly discharging dummy discharge droplets corresponding to three dots continuously in the Y direction, onto an area corresponding twelve dots in the medium feed direction, which is reserved as a flushing area. In the flushing pattern D, the number of droplets continuously discharged is zero in the X direction and three in the Y direction.

Flushing (FL) pattern E of FIG. 8E is a pattern formed by discharging dummy discharge droplets per two nozzles (per two dots) in the X direction and dummy discharge droplets corresponding to three dots continuously in the Y direction, stops discharging for a time period corresponding to one dot in the Y direction, then switching the nozzles to discharge dummy discharge droplets, and similarly discharging dummy discharge droplets corresponding to three dots continuously in the Y direction, onto an area corresponding seven dots in the medium feed direction, which is reserved as a flushing area. In the flushing pattern E, the number of droplets continuously discharged is zero in the X direction and three in the Y direction.

Here, the flushing pattern A is selected for, for example, media for transaction, such as plain sheets of paper, which have good drying properties and is not subject to image stain even when liquid droplets are discharged in high density. For the flushing pattern A, dummy discharge droplets can be discharged in higher density and higher frequency than the other flushing patterns B to E.

By contrast, for example, for media having poor drying properties, such as typical coated sheets of paper, image stain is likely to occur in the flushing pattern A. Therefore, a flushing pattern other than the flushing pattern A is used.

For example, for the flushing pattern B, the discharge frequency is adjustable to discharge a desired amount of liquid. The flushing pattern B is suitable, for example, when printing is performed at high density in the medium feed direction or when the amount of liquid per droplet is increased relative to the resolution.

Flushing pattern C is suitable for long time printing. By contrast, for example, when transfer stain of an image occurs in the flushing pattern C, the long time printing may be divided and performed using the flushing pattern A to reduce the amount of thickened liquid remaining in the nozzles.

Flushing pattern D is suitable when it takes a relatively long time to dry media or liquid. Since the flushing area of the flushing pattern D is lager than that of any other flushing pattern, the flushing pattern D is preferably used only when such a larger flushing area is reserved.

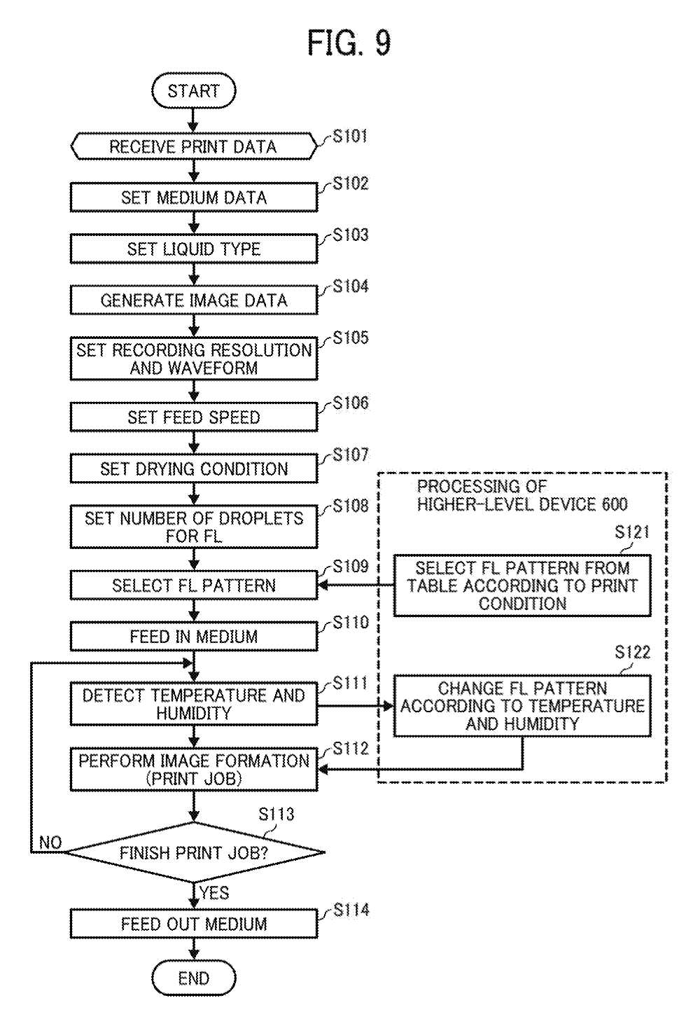

Next, an example of a general flow of print control is described with reference to FIG. 9.

At S101, print data is received. The print data includes, for example, print mode, image size, color information, and the number of pages.

At S102, data on a medium to be used (the continuous medium 10) is set. Here, data on the medium includes, for example, information on media type, such as plain paper, inkjet paper, and coated paper, and information on the thickness of media. The content (information) set at S102 is transferred to the higher-level device 600.

At S103, the type of liquid to be used is set and transferred to the higher-level device 600.

At S104, the higher-level device 600 generates image data from the received print data.

At S105, the resolution of recording is set and transferred to the higher-level device 600. Note that the drive waveform to drive the liquid discharge head is automatically selected in accordance with the resolution of recording. At S105, the discharge amount of liquid per droplet is also determined in accordance with the drive waveform. When the resolution of recording is already contained in image data, the condition is automatically set.

At S106, the medium feed speed, that is print speed is set and transferred to the higher-level device 600.

At S107, the drying condition is set and transferred to the higher-level device 600. Note that, for the drying condition, if a low drying temperature is set, liquid is unlikely to dry. If liquid does not dry, an image would degrade. Hence, the drying condition may be automatically set based on conditions, such as print data, media, liquid, image data, and resolution.

At S108, the number of flushing droplets (the number of dummy discharge droplets) is set and transferred to the higher-level device 600. Note that, when as plurality of different types of liquid is used, the number of flushing droplets may be changed in accordance with the liquid type.

At S109, the flushing pattern (dummy discharge pattern) of the line flushing operation is selected. The flushing pattern is set in accordance with, for example, media type, liquid type, resolution of recording, feed speed, drying condition, and flushing condition (the number of dummy discharge droplets. As illustrated in FIG. 9, at S121, the higher-level device 600 selects a flushing pattern from a table, as illustrated in FIG. 15, according to the print conditions.

At S110, the medium 10 is fed.

At S111, the ambient conditions (e.g., ambient temperature and ambient humidity) are detected and the detection results are transferred to the higher-level device 600. At S122, the higher-level device 600 changes the flushing pattern according to, e.g., the ambient temperature and humidity detected at S111. Note that, during execution of a print job, feedback of detection results of the ambient conditions are regularly repeated until the end of the print job. A reason of execution of the feedback is that there is a concern about a change in the ambient temperature and humidity for an apparatus, such as a continuous feed printing system, which takes a relatively long time per job. Note that, without detecting the ambient temperature and humidity of the head, line flushing may be performed based on the conditions set in executing the print job.

At S112, the image formation (the print job) is performed and an image formed is fed out. At S113, the print job is finished.

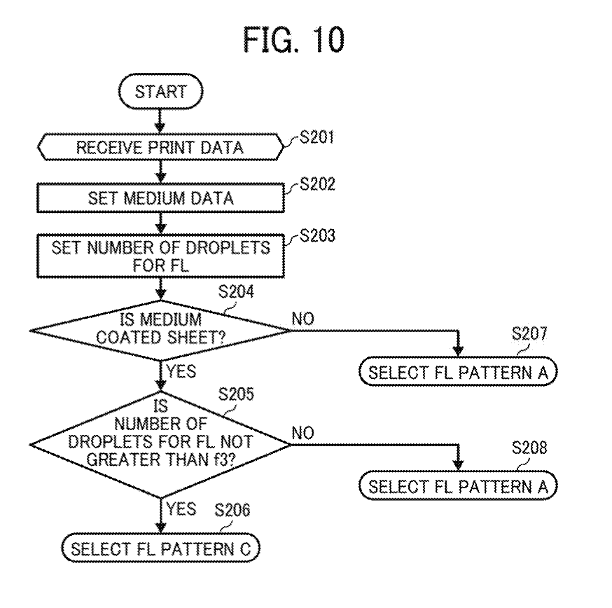

Next, a control on selection of the flushing pattern in a first embodiment of the present disclosure is described with reference to FIG. 10.

At S201, print data is received. At S202, data on the medium 10 is set. At S203, the number of flushing droplets is set.

At S204, it is determined whether the type of the medium 10 is a coated sheet of paper.

When the medium 10 is a coated sheet (YES at S204), at S205 it is determined whether the number of flushing droplets is not greater than a threshold value f3. When the number of flushing droplets is not greater than f3 (YES at S205), the flushing pattern C is selected. By contrast, when the number of flushing droplets is greater than f3 (NO at S205), at S208 the flushing pattern A is selected.

When the medium 10 is not a coated sheet (NO at S204), at S207 the flushing pattern A is directly selected.

As described above, in the present embodiment, dummy discharge is performed by selecting the flushing pattern in accordance to the number of flushing droplets and the medium type.

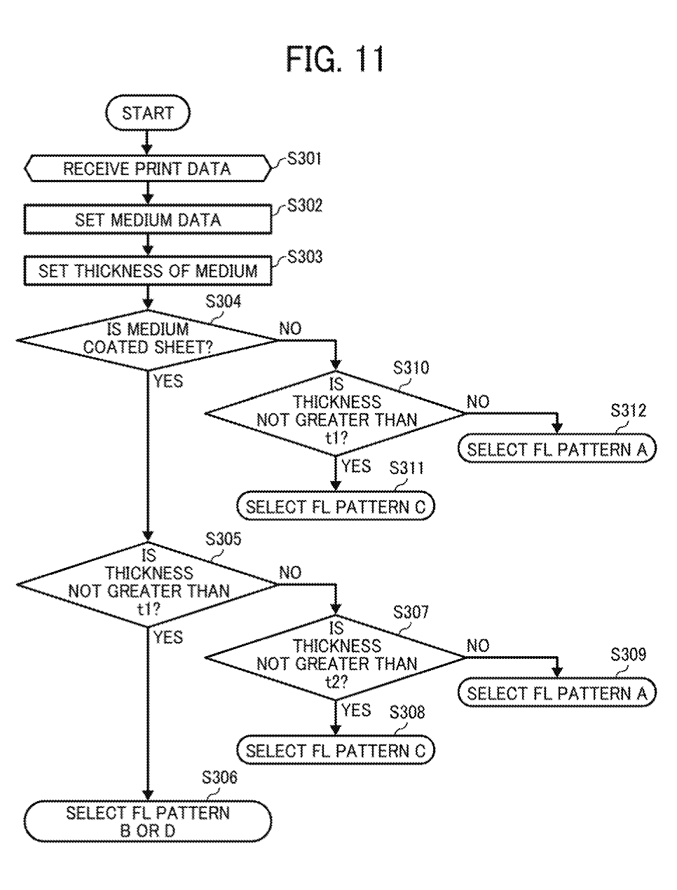

Next, a control on selection of the flushing pattern in a second embodiment of the present disclosure is described with reference to FIG. 11.

At S301, print data is received. At S302, data on the medium 10 is set. At S303, the thickness of the medium 10 is set.

At S304, it is determined whether the type of the medium 10 is a coated sheet of paper.

Here, when the medium 10 is a coated sheet (YES at S304), at S305 it is determined whether the thickness of the medium 10 is not greater than a first predetermined thickness t1.

When the thickness of the medium 10 is not greater than the first predetermined thickness t1 (YES at S305), at S306 the flushing pattern B or D is selected. By contrast, when the thickness of the medium 10 is greater than the first predetermined thickness t1 (NO at S305), at S307 it is determined whether the thickness of the medium 10 is not greater than a second predetermined thickness t2 (t2>t1).

When the thickness of the medium 10 is not greater than the second predetermined thickness t2 (t2>t1) (YES at S307), at S308 the flushing pattern C is selected. By contrast, when the thickness of the medium 10 is greater than the second predetermined thickness t2 (NO at S307), at S309 the flushing pattern A is selected.

Alternatively, when the medium 10 is not a coated sheet (NO at S304), at S310 it is determined whether the thickness of the medium 10 is not greater than the first predetermined thickness t1. When the thickness of the medium 10 is not greater than the first predetermined thickness t1 (YES at S310), at S311 the flushing pattern C is selected. B contrast, when the thickness of the medium 10 is greater than the predetermined thickness t1 (NO at S307), at S312 the flushing pattern A is selected.

As described above, in the present embodiment, dummy discharge is performed by selecting the flushing pattern in accordance to the type and thickness of the medium.

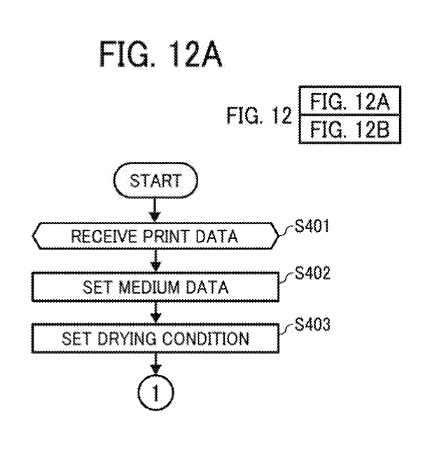

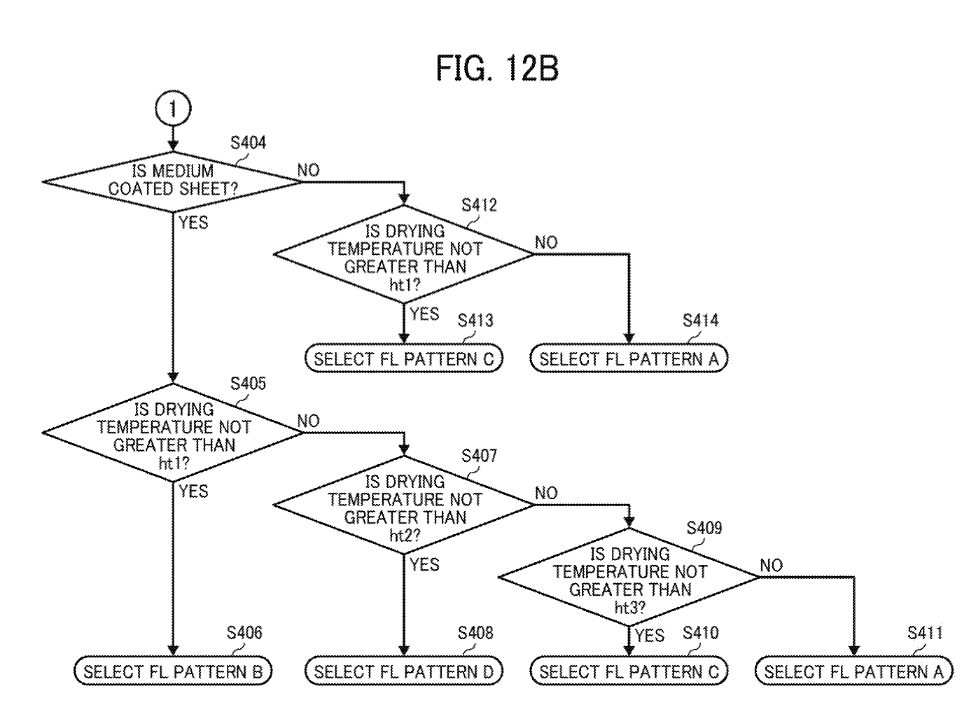

Next, a control on selection of the flushing pattern in a third embodiment of the present disclosure is described with reference to FIGS. 12A and 12B (collectively referred to as FIG. 12).

At S401, print data is received. At S402, data on the medium 10 is set. At S403, the drying condition is set.

At S404, it is determined whether the type of the medium 10 is a coated sheet of paper.

Here, when the medium 10 is a coated sheet (YES at S404), at S405 it is determined whether the drying temperature in the drying condition is not greater than a first predetermined temperature ht1.

When the drying temperature is not greater than the first predetermined temperature ht1 (YES at S405), at S406 the flushing pattern B is selected.

By contrast, when the drying temperature is greater than the first predetermined temperature ht1 (NO at S405), at S407 it is determined whether the drying temperature is not greater than a second predetermined temperature ht2 (ht2>ht1).

When the drying temperature is not greater than the second predetermined temperature ht2 (YES at S407), at S408 the flushing pattern D is selected. By contrast, when the drying temperature is greater than the second predetermined temperature ht2 (NO at S405), at S409 it is determined whether the drying temperature is not greater than a third predetermined temperature ht3 (ht3>ht2).

When the drying temperature is not greater than the third predetermined thickness t3 (YES at S409), at S410 the flushing pattern C is selected. By contrast, when the drying temperature is not greater than the third predetermined thickness t3 (NO at S409), at S411 the flushing pattern A is selected.

When the medium 10 is not a coated sheet (NO at S404), at S412 it is determined whether the drying temperature is not greater than the first predetermined temperature ht1.

When the drying temperature is not greater than the first predetermined thickness t1 (YES at S412), at S413 the flushing pattern C is selected. By contrast, when the drying temperature is not greater than the first predetermined thickness t1 (NO at S412), at S414 the flushing pattern A is selected.

As described above, in the present embodiment, dummy discharge is performed by selecting the flushing pattern in accordance to the medium type and the drying condition.

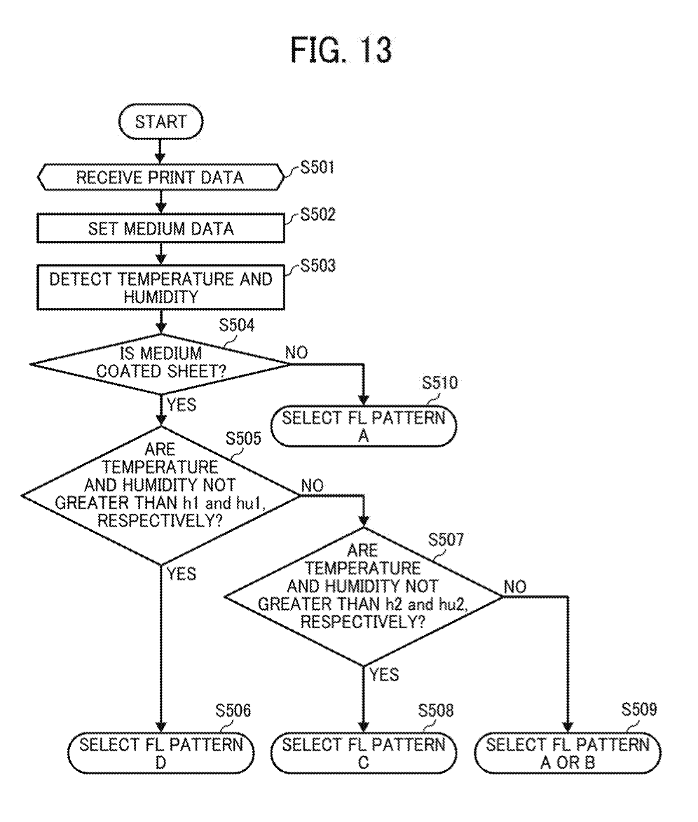

Next, a control on selection of the flushing pattern in a forth embodiment of the present disclosure is described with reference to FIG. 13.

At S501, print data is received. At S502, data on the medium 10 is set. At S503, the temperature and humidity are detected.

At S504, it is determined whether the type of the medium 10 is a coated sheet of paper.

Here, when the medium 10 is a coated sheet (YES at S504), at S505 it is determined whether the ambient temperature is not greater than a first predetermined temperature h1 and the ambient humidity is not greater than a first predetermined, humidity hu1.

When the ambient temperature is not greater than the first predetermined temperature h1 and the ambient humidity is not greater than the first predetermined humidity hu1 (YES at S505), at S506, the flushing pattern D is selected. By contrast, when the ambient temperature is greater than the first predetermined temperature h1 and the ambient humidity is greater than the first predetermined humidity hu1 (NO at S505), at S507 it is determined whether the ambient temperature is not greater than the second predetermined temperature h2 (h2>h1) and the ambient humidity is not greater than a second predetermined humidity hu2 (hu2>hu1).

When the ambient temperature is not greater than the second predetermined temperature h2 and the ambient humidity is greater than a second predetermined humidity hu2 (YES at S507), at S508 the flushing pattern C is selected. By contrast, when the ambient temperature is greater than the second predetermined temperature h2 and the ambient humidity is greater than a second predetermined humidity hu2 NO at S507), at S509 the flushing pattern A or B is selected.

When the medium 10 is not a coated sheet (NO at S504), at S510 the flushing pattern A is selected.

As described above, in the present embodiment, dummy discharge is performed by selecting the flushing pattern in accordance to the medium type and the ambient temperature and humidity.

In some embodiments, dummy discharge may be performed by selecting the flushing pattern in accordance to the feed speed (print speed) of the medium 10.

Since the drying time varies with the medium feed speed, the adhesion amount of liquid per area of the medium is changed. For example, as the medium feed speed is lower, the drying time can be set to be longer. Accordingly, the allowable adhesion amount of liquid per area of the medium increases, thus allowing dummy discharge to be performed at higher density. By contrast, as the medium feed speed is higher, the allowable adhesion amount of liquid per area of the medium decreases. Accordingly, a flushing pattern of lower density is used.

In some embodiments, dummy discharge may be performed by selecting the flushing pattern in accordance to the resolution of recording.

In such a case, the drive waveform and the discharge cycle are determined based on the resolution of recording, thus allowing dummy discharge to be controlled with a flushing pattern in accordance with the resolution. Since the drive waveform is determined by the resolution, the amount of liquid per droplet is greater as the resolution is lower. Accordingly, when line flushing is performed with similar drive frequencies, the discharge amount of liquid per droplet is greater in the line flushing at lower resolution, which is disadvantageous in drying. Hence, the amount of liquid discharged in flushing pattern is preferably controlled to prevent drying failure.

In some embodiments, dummy discharge may be performed by selecting the flushing pattern to be used in accordance with the amount of water or solvent in liquid.

As the amount of water or solvent is greater, the drying properties are poorer. Therefore, when liquid containing a greater amount of water or solvent is used, a flushing pattern at lower density is preferably used to prevent degradation of image qualities due to drying failure.

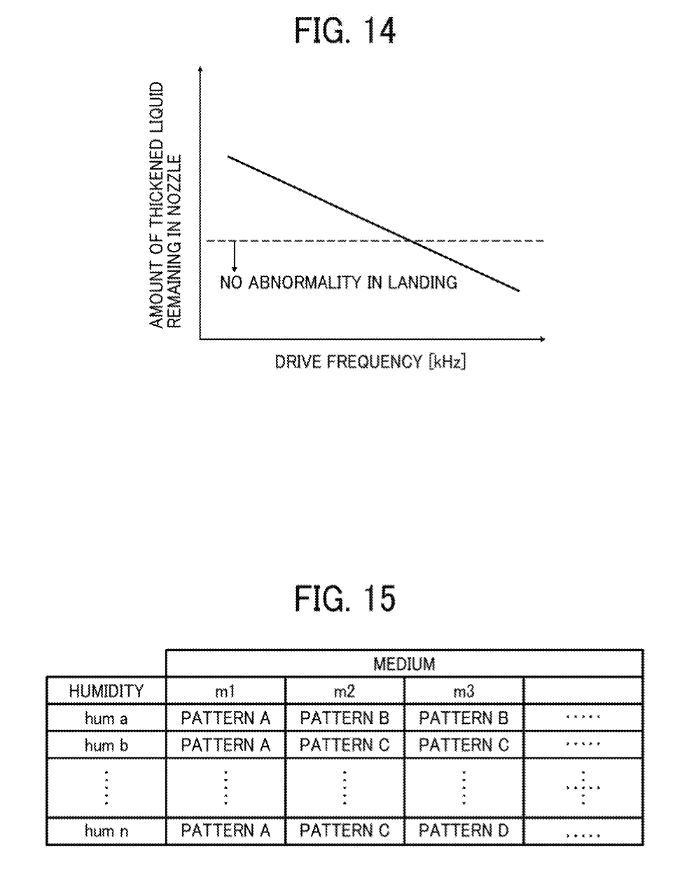

Next, an example of the relationship between the drive frequency and the amount of thickened liquid in nozzle during continuous printing is described with reference to FIG. 14.

When continuous printing is performed under the same conditions, the amount of thickened liquid remaining in nozzle is smaller as the drive frequency of the head. When the amount of thickened liquid in nozzle is a threshold amount or more, discharge failure (abnormal landing) occurs, thus affecting print qualities.

Hence, by selecting a flushing pattern to perform line flushing at as higher a drive frequency as possible, the amount of thickened liquid remaining in nozzle is limited to prevent abnormal landing.

Next, an example of a table of the relationship between humidity, medium type, and flushing pattern is described with reference to FIG. 15.

Such a table associating ambient humidities with flushing patterns is stored and retained in a storage device (e.g., the ROM 602 or the HDD 604 of the higher-level device 600 or the ROM 512 of the main controller 501), and a flushing pattern is read out in accordance with a detected ambient humidity to perform dummy discharge. For example, in the table illustrated in FIG. 15, according to, e.g., medium type and thickness, n tables of ml to mn are stored and retained that associate the ambient humidities hum a to hum n with dummy discharge patterns to be used.

Note that, since thickened liquid remaining in nozzle is likely to occur, the drive frequency is set to be higher as the humidity is lower. In addition, the number or amount of droplets to be discharged may be adjusted.

Since an area in which line flushing is performed is a waste sheet, the width of the flushed area in the medium feed direction is preferably small. If the adhesion amount of dummy discharge droplets is excessive, the continuous medium is fed with dummy discharge droplets not dried. Such droplets adhere to, e.g., a conveyance roller, thus causing image stain.

By contrast, when the amount of liquid discharged in dummy discharge is reduced, thickened liquid in nozzles may not sufficiently be discharged during long-time continuous printing, thus causing a discharge failure.

Hence, as described above, according to embodiments of the present disclosure, a plurality of dummy discharge patterns is retained that differs from each other in the number of droplets continuously discharged in at least one of a feed direction of a medium and a direction perpendicular to the feed direction. With such a configuration, a proper dummy discharge pattern is selected in accordance with various conditions, thus allowing reliable recovery of nozzle conditions with smaller consumption amount of liquid.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A liquid discharge apparatus comprising:
a liquid discharge had including a plurality of nozzles to discharge liquid onto a continuous medium;
a dummy discharge controller configured to control the liquid discharge head to discharge dummy discharge droplets linearly in an inter-page area of die continuous medium; and
a storage device configured to retain a plurality of dummy discharge patterns that differs front each other in number of droplets continuously discharged in at least one direction of a feed direction of the continuous medium and a direction perpendicular to the feed direction.

2. The liquid discharge apparatus according to claim 1,
wherein the dummy discharge controller selects from the plurality of dummy discharge patterns, a dummy discharge pattern to be used in accordance with a feed speed of the continuous medium.

3. The liquid discharge apparatus according to claim 1,
wherein the dummy discharge controller selects, from the plurality of dummy discharge patterns, a dummy discharge pattern to be used in accordance with a resolution of an image to be formed on the continuous medium.

4. The liquid discharge apparatus according to claim 1,
wherein the dummy discharge controller selects, from the plurality of dummy discharge patterns, a dummy discharge pattern to be used in accordance with an amount of water or solvent contained in the liquid.

5. The liquid discharge apparatus according to claim 1,
wherein the dummy discharge controller selects, from the plurality of dummy discharge patterns, a dummy discharge pattern to be used in accordance with a number of dummy discharge droplets to be discharged from the liquid discharge head.

6. The liquid discharge apparatus according to claim 1,
wherein the dummy discharge controller selects, from the plurality of dummy discharge patterns, a dummy discharge pattern to be used in accordance with a thickness of the continuous medium.

7. The liquid discharge apparatus according to claim 1,
wherein the dummy discharge controller selects, from the plurality of dummy discharge patterns, a dummy discharge pattern to be used in accordance with a drying condition of the continuous medium.

8. The liquid discharge apparatus according to claim 1,
wherein the dummy discharge controller selects, from the plurality of dummy discharge patterns, a dummy discharge pattern to be used in accordance with an ambient condition.
